(19) United States
(12) Patent Application Publication
(10) Pub. No.: US 2020/0181317 A1
(43) Pub. Date: Jun. 11, 2020

(54) Bisphenol A-Free Crosslinked Polymer Composition

(71) Applicant: WARNER BABCOCK INSTITUTE FOR GREEN CHEMISTRY, LLC, Wilmington, MA (US)

(72) Inventors: John C. Warner, Wilmington, MA (US); Justin Whitfield, Billerica, MA (US); Frederick R. Kearney, Walpole, MA (US); Jeffrey Gladding, Burlington, MA (US); Anitha Hari, High Point, NC (US)

(73) Assignee: WARNER BABCOCK INSTITUTE FOR GREEN CHEMISTRY, LLC, Wilmington, MA (US)

(21) Appl. No.: 16/313,538

(22) PCT Filed: Jun. 27, 2017
(86) PCT No.: PCT/US2017/039410

§ 371 Date: Dec. 27, 2018

Related U.S. Application Data
(60) Provisional application No. 62/355,074, filed on Jun. 27, 2016.

(51) Int. Cl. C08G 59/62; C08L 67/06; C08G 59/32; C09D 163/10

(52) U.S. Cl. CPC C08G 59/621; C09D 163/10; C08G 59/3218; C08L 67/06

(57) ABSTRACT

The present application discloses improved BPA-free crosslinked polymers comprising a bis-electrophile and a polynucleophile, useful in commercial employment as can linings and such. Exemplary embodiments comprise a dianhydride and a polyol, a bis-phenol (other than BPA) and a polyepoxide, a bis-epoxide and a polyphenol, and a bis-styrene and an unsaturated polyester.

### TECHNICAL FIELD

Described herein are crosslinked polymeric materials useful in the manufacture of can linings and other uses. More particularly, described herein are new Bisphenol A-free crosslinkers and polymers used in the manufacture of crosslinked polymeric materials that provide improved properties to such materials.

### BACKGROUND

Commercially manufactured food and beverage cans typically consist of aluminum or tin-plated steel cans spray-coated and heat-cured with an aqueous epoxy resin. The aqueous epoxy resin usually contains phenolic polymer crosslinked with bisphenol A (BPA) diglycidyl ether in varying ratios.

Although the polymeric linings in metal cans pose few technical challenges, studies on the endocrine disrupting effects of BPA and its structural analogs have stirred controversy and consumer concern. Because of these safety concerns, a demand has arisen for a chemically different, BPA-free and generally toxin-free lining in aluminum and steel cans that can be easily integrated into current manufacturing processes.

### SUMMARY

Described herein are crosslinked polymeric compositions and components thereof that are cheaper and BPA-free. The technology described herein is easily applicable to existing processing parameters and production equipment.

Accordingly, described herein is a spray composition for a can lining comprising a polynucleophile and a bis-electrophile. Preferably, the the polynucleophile/bis-electrophile pair is selected from the group consisting of polyol/dianhydride, polyphenol/bis-epoxide, polyepoxide/bisphenol, and unsaturated polyester/bis-styrene.

Further described herein is a method of making a crosslinked polymer, the method comprising the steps of (a) dissolving a bis-electrophile in a solvent to form a solution, (b) optionally adding an accelerator to the solution, then (c) adding a polynucleophile to the solution, and then (d) stirring the resultant solution.

Additionally described herein is a crosslinked polymer made by a method comprising the steps of (a) dissolving a bis-electrophile in a solvent to form a solution, (b) optionally adding an accelerator to the solution, then (c) adding a polynucleophile to the solution, and then (d) stirring the resultant solution.

Also described herein is a bis-epoxide selected from the group consisting of:

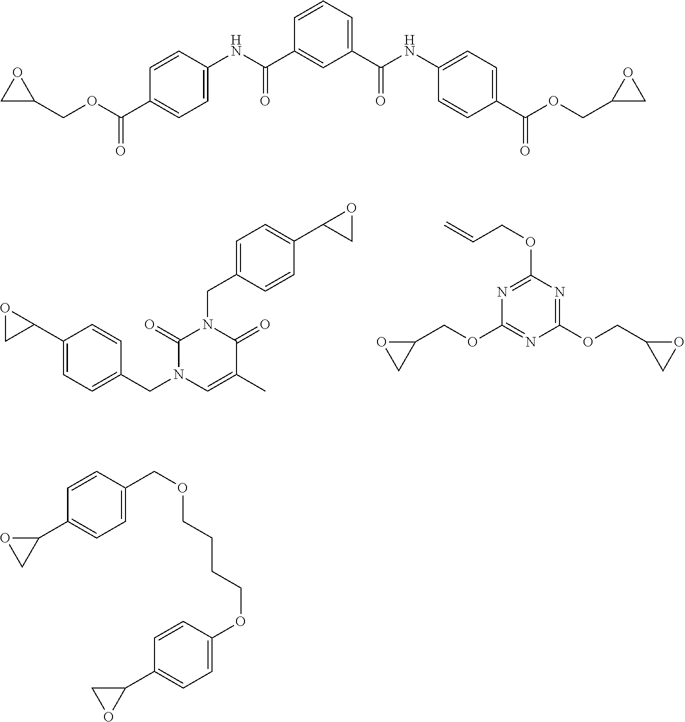 [SMILES: O=C(Nc1ccc(C(=O)OCC2CO2)cc1)c1cccc(C(=O)Nc2ccc(C(=O)OCC3CO3)cc2)c1 ; Cc1cn(Cc2ccc(C3CO3)cc2)c(=O)n(Cc2ccc(C3CO3)cc2)c1=O ; C=CCOc1nc(OCC2CO2)nc(OCC2CO2)n1 ; c1cc(C2CO2)ccc1COCCCCOc1ccc(C2CO2)cc1]

Further described herein is a bisphenol selected from the group consisting of:

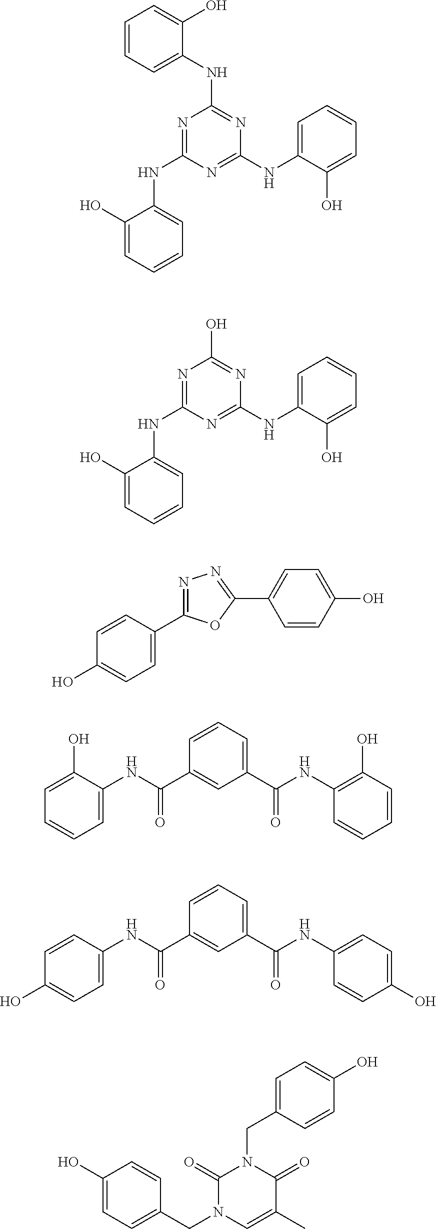 [SMILES: Oc1ccccc1Nc1nc(Nc2ccccc2O)nc(Nc2ccccc2O)n1 ; Oc1nc(Nc2ccccc2O)nc(Nc2ccccc2O)n1 ; Oc1ccc(-c2nnc(-c3ccc(O)cc3)o2)cc1 ; O=C(Nc1ccccc1O)c1cccc(C(=O)Nc2ccccc2O)c1 ; O=C(Nc1ccc(O)cc1)c1cccc(C(=O)Nc2ccc(O)cc2)c1 ; Cc1cn(Cc2ccc(O)cc2)c(=O)n(Cc2ccc(O)cc2)c1=O]

Still further described herein is a bis-styrene selected from the group consisting of:

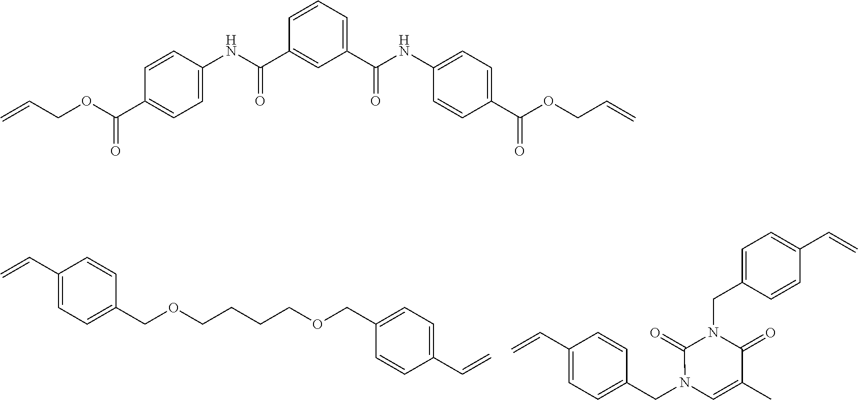

Additionally described herein is an unsaturated polyester polymer selected from the structures of formulae IV, V and VI:

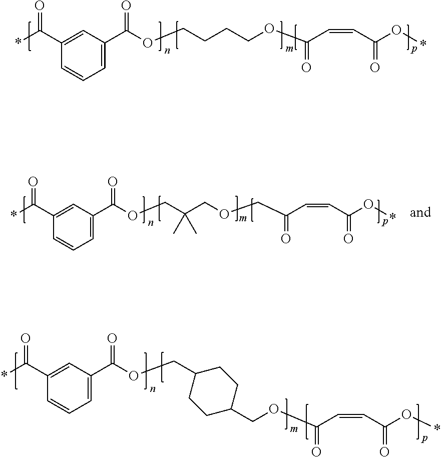

wherein n, m, and p are integers together denoting the fraction of each monomer or group in the polymer.

The following embodiments, aspects and variations thereof are exemplary and illustrative, and are not intended to be limiting in scope.

### DETAILED DESCRIPTION

### Definitions

Unless specifically noted otherwise herein, the definitions of the terms used are standard definitions used in the art of construction materials and chemistry science. Exemplary embodiments, aspects and variations are illustrative in the figures and drawings, and it is intended that the embodiments, aspects and variations, and the figures and drawings disclosed herein are to be considered illustrative and not limiting.

As used herein, the term “accelerator” refers to an optional component of the crosslinked polymeric material that can accelerate the material-forming process.

As used herein, the term “bis-electrophile” refers to a molecule with two electrophilic regions, i.e., two portions of the molecule that are attracted to electron-rich (nucleophilic) regions, or are electron-pair receptors. Bis-electrophiles include diketones, diesters, dianhydrides, bis-epoxides, bis-styrenes and bisphenols other than Bisphenol A.

As used herein, the term “polynucleophile” refers to a molecule with two or more nucleophilic regions, i.e., two portions of the molecule that are attracted to electron-poor (electrophilic) regions, or are electron-pair acceptors. Polynucleophiles include, but are not limited to polyols, polyphenols, polyamines, polythiols, polyamides, polyethers, polyepoxides, and unsaturated polyesters.

As used herein, an “alkyl” group is a straight, branched, saturated or unsaturated, aliphatic group having a chain of carbon atoms, optionally with oxygen, nitrogen or sulfur atoms inserted between the carbon atoms in the chain or as indicated. A C₁₋₂₀ alkyl (or C₁-C₂₀ alkyl), for example, includes alkyl groups that have a chain of between 1 and 20 carbon atoms, and include, for example, the groups methyl, ethyl, propyl, isopropyl, vinyl, allyl, 1-propenyl, isopropenyl, ethynyl, 1-propynyl, 2-propynyl, 1,3-butadienyl, penta-1,3-dienyl, penta-1,4-dienyl, hexa-1,3-dienyl, hexa-1,3,5-trienyl, and the like.

An alkyl as noted with another group such as an aryl group, represented as “arylalkyl” for example, is intended to be a straight, branched, saturated or unsaturated aliphatic divalent group with the number of atoms indicated in the alkyl group (as in C₁₋₂₀ alkyl, for example) and/or aryl group (as in C₅₋₁₀ aryl or C₆₋₁₀ aryl, for example) or when no atoms are indicated means a bond between the aryl and the alkyl group. Nonexclusive examples of such group include benzyl, phenethyl and the like.

A “cyclyl” group, such as a monocyclyl or polycyclyl group includes monocyclic, or linearly fused, angularly fused or bridged polycycloalkyl, or combinations thereof. Such cyclyl groups are intended to include the heterocyclyl analogs. A cyclyl group may be saturated, partically saturated, or aromatic.

A “heterocyclyl” or “heterocycle” is a cycloalkyl wherein one or more of the atoms forming the ring is a heteroatom that is a N, O or S. Heterocycles are typically 5, 6 or 7-membered rings that maybe fused to additional rings. A heterocyclyl includes aromatic heterocyclyl and non-aromatic heterocyclyl groups. Non-exclusive examples of heterocyclyl include oxazolyl, 4-imidazolyl, 5-imidazolyl, piperidyl, 4-morpholyl, 4-piperazinyl, pyrrolidinyl, 1,4-diazaperhydroepinyl, 1,3-dioxanyl, and the like. Heterocyclyl also includes thyminyl, adeninyl, guaninyl, cytosinyl, uracilyl and derivatives thereof.

### Crosslinked Polymeric Compositions

Described herein are crosslinked polymeric compositions that are useful in, among other things, providing can linings that have improved performance characteristics while also minimizing environmental impact by using green substitutes in the adhesive component.

The compositions described herein comprise a bis-electrophile and a polynucleophile. In some embodiments, the bis-electrophile is a dianhydride, and the polynucleophile is a polyol. In other embodiments, the bis-electrophile is a bis-epoxide and the polynucleophile is a polyphenol. In still other embodiments, the bis-electrophile is a bisphenol other than bisphenol-A, and the polynucleophile is a polyepoxide. In further embodiments, the bis-electrophile is a bis-styrene and the polynucleophile is an unsaturated polyester.

### Polynucleophiles

The polynucleophiles useful in the compositions described herein are molecules with two or more nucleophilic regions, i.e., two portions of the molecule that are attracted to electron-poor (electrophilic) regions, or are electron-pair acceptors. The polynucleophiles include, but are not limited to polyols, polyamines, polythiols, polyamides, polyethers, polyphenols, polyepoxides and unsaturated polyesters.

Exemplary polynucleophiles for use in the compositions described herein are polyols, polyphenols, polyepoxides and unsaturated polyesters. Suitable polynucleophiles may be polyols—polymeric alcohols, or organic compounds with two or more hydroxy groups. Suitable polyols include polyester polyols, polyether polyols, and combinations thereof. Further, the polyol can be selected from the group of, but is not limited to, aliphatic polyols, cycloaliphatic polyols, aromatic polyols, heterocyclic polyols, and combinations thereof. More specific examples of suitable polyols are selected from the group of, but are not limited to, glycerols, propylene glycols, sucrose-initiated polyols, sucrose/glycerine-initiated polyols, trimethylolpropane-initiated polyols, and combinations thereof.

Other useful polyols include those listed below in Table 1.

TABLE 1
Representative Polyols.

| | | |
|---|---|---|
| Trade name or | % | |
| manufacturer | hydrolyzed | MW |

Poly(vinyl alcohol) (PVA)

| | | |
|---|---|---|
| POVAL LM-10HD | 38.0-42.0% | unknown |
| POVAL LM-20 | 38.0-42.0% | unknown |
| Acros (P/N 30278) | 78% | 6K |
| Sigma-Aldrich (P/N 363170) | 87-88% | 13-23K |
| Sigma-Aldrich (P/N 341584) | 99+%, | 89-98K |
| Sigma-Aldrich (P/N 363146) | 99+% | 86-124K |
| Mowiol ® 8-88 | 86.7-88.7% | ~67K |
| Mowiol ® 18-88 | 86.7-88.7% | 130K |
| Mowiol ® 40-88 | 86.7-88.7% | 205K |

Styrene allyl alcohol (SAA) copolymers

| | | |
|---|---|---|
| SAA-100 ™ (LyondellBasell) | 70:30 styrene: | 3K |
| | allyl alcohol | |
| SAA-101 ™ (LyondellBasell) | 60:40 styrene: | 2.5K |
| | allyl alcohol | |

Partially-hydrolyzed polyvinyl butyral (PVB)

| | | |
|---|---|---|
| BUTVAR ® B-72, as | 17.5-20.0% as | 170-250K |
| BUTVAR ® RS-261 | polyvinyl | |
| dispersion in water | alcohol | |
| SharkPelletsC3 ™ | not specified | not specified |

Ethylene vinyl alcohol co-polymer

| | |
|---|---|
| EVAL ™ EVOH C109B | 35% ethylene; |
| | 65% vinyl |
| | alcohol |

Small molecule polyols/ molecular polyols

| | | |
|---|---|---|
| 1,4-butanediol | diol | 90.12 |
| 1,3-propanediol | diol | 76.09 |
| 1,6-hexanediol | diol | 118.17 |
| diethylene glycol | diol | 106.12 |
| 1,1,1- | triol | 134.17 |
| tris(hydroxymethyl)propane | | |
| triethanol amine | triol | 149.19 |
| 9:1 (w:w) 1,6- | diol/triol | 118.17, 149.19 |
| hexanediol:triethanolamine | mixture | |

Optionally, mixtures of the polyols may be used. Mixtures of polyols may be used so as to improve on dispersability or solubility of a polyol. For example, it was found that it was possible to form a homogeneous mixture of SAA-100 in a dispersion of 10 wt % Mowiol® 40-88 in water but not in neat water.

Another class of exemplary polynucleophiles are the polyphenols. Suitable polyphenols include phenol formaldehyde resins, novolacs (such as phenol, cresol, or xylenol novolac), resoles, poly(vinylphenol) and poly (vinyl phenol/co-MMA). Additional polyphenols have the structure of formula I:

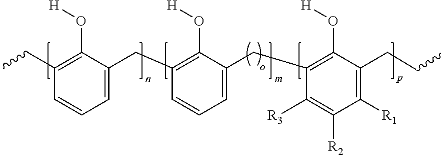

wherein
n, m, and p are integers together denoting the fraction of each monomer or group in the polymer; o=1, 2 or 3; and
R¹, R², and R³ are independently selected from the group consisting of H and C₁₋₈ linear or branched alkyl.
(In the above notation for co-polymers, as used throughout this application, the n, m and p units may appear in any order—the formula is only intended to define the relative proportion of monomer units, and not the exact order (which is random) in the co-polymer.) Preferred polyphenols described herein are Novolac and poly(vinyl phenol). Optionally, mixtures of polyphenols may also be used.

Still another class of exemplary polynucleophiles are the polyepoxides. Suitable polyepoxides include epoxynovolacs, having the structure of formula II:

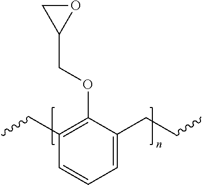

An exemplary epoxy novolac is the epoxy cresol novolac Epon Resin 164.

Another suitable class of polyepoxides are glycidyl (meth)acrylate co-polymers, having the structure of formula III:

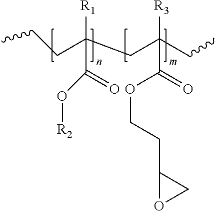

wherein
n and m, are integers together denoting the fraction of each monomer or group in the polymer;
R¹ and R³ are H or methyl: and
R² is C₁₋₈ linear or branched alkyl.
Optionally, mixtures of polyepoxides may also be used.

Yet another class of exemplary polynucleophiles are the unsaturated polyesters. Preferred unsaturated polyesters are copolymers of maleic acid, a disubstituted aromatic diacid and a common diol. A preferred disubstituted aromatic diacid is isophthalic acid: any diol may be used, but preferred diols include 1,4-butanediol, 2,2-dimethyl-1,3-propanediol, and cyclohexane-1,4-dimethanol. Exemplary structures of the unsaturated polyesters described herein have structures of formulae IV, V and VI:

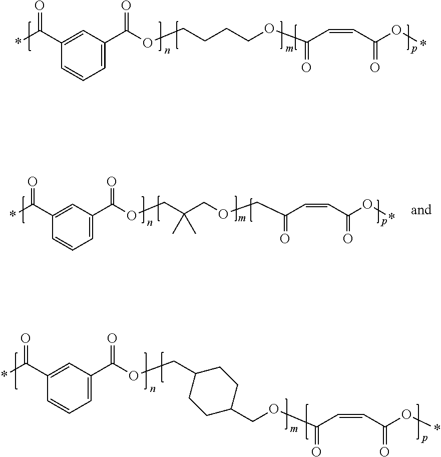

wherein
n, m, and p are integers together denoting the fraction of each monomer or group in the polymer. Optionally, mixtures of unsaturated polyesters may also be used.

### Bis-Electrophiles

Suitable bis-electrophiles for use in the compositions described herein are molecules with at least two electrophilic regions, i.e., two portions of the molecule that are attracted to electron-rich (nucleophilic) regions, or are electron-pair receptors. Bis-electrophiles include diketones, diesters, bis-epoxides, bis-phenols (other than bisphenol A), bis-styrenes and dianhydrides. A suitable bis-electrophile may include at least one cyclic structure that is opened when reacted with a nucleophile like the polynucleophiles described herein.

An exemplary bis-electrophile is a dianhydride. Exemplary dianhydrides for use in the compositions described herein are shown in Table 2.

TABLE 2
Representative Dianhydrides

| Compound | Structure |
|---|---|
| Benzophenone-3,3′,4,4′- tetracarboxylic dianhydride (BPDA) | 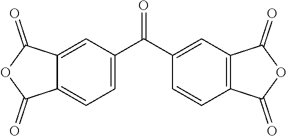 [SMILES: O=C(c1ccc2c(c1)C(=O)OC2=O)c1ccc2c(c1)C(=O)OC2=O] |
| 4,4′-Oxydiphthalic anhydride (ODPA) | 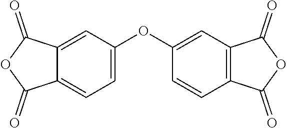 [SMILES: O=C1OC(=O)c2cc(Oc3ccc4c(c3)C(=O)OC4=O)ccc21] |
| 4,4′-Biphthalic anhydride [aka diphenyl-3,3′,4,4′-tetracarboxylic dianhydride] | 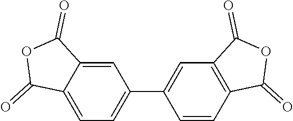 [SMILES: O=C1OC(=O)c2cc(-c3ccc4c(c3)C(=O)OC4=O)ccc21] |
| Bicyclo[2.2.2]oct-7-ene-2,3,5,6- tetracarboxylic dianhydride | 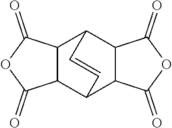 [SMILES: O=C1OC(=O)C2C3C=CC(C12)C1C(=O)OC(=O)C31] |
| Pyromellitic dianhydride | 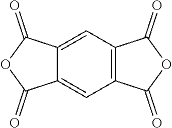 [SMILES: O=c1oc(=O)c2cc3c(=O)oc(=O)c3cc12] |
| 3,4,9,10-Perylenetetracarboxylic Dianhydride [Pigment Red 224] | 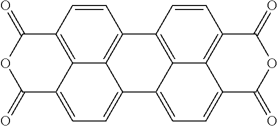 [SMILES: O=C1OC(=O)c2ccc3c4ccc5c6c(ccc(c7ccc1c2c73)c64)C(=O)OC5=O] |
| 1,2,4,5-Cyclohexanetetracarboxylic dianhydride | 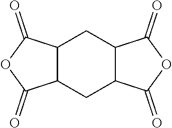 [SMILES: O=C1OC(=O)C2CC3C(=O)OC(=O)C3CC12] |
| 3,4′-Oxydiphthalic Anhydride | 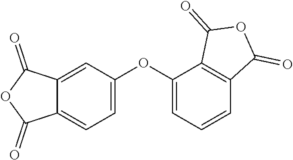 [SMILES: O=C1OC(=O)c2cc(Oc3cccc4c3C(=O)OC4=O)ccc21] |
| Naphthalene-1,4,5,8-tetracarboxylic Dianhydride | 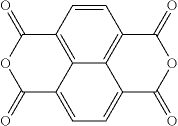 [SMILES: O=C1OC(=O)c2ccc3c4c(ccc1c24)C(=O)OC3=O] |
| 4,4′-(4,4′- Isopropylidenediphenoxy)diphthalic Anhydride | 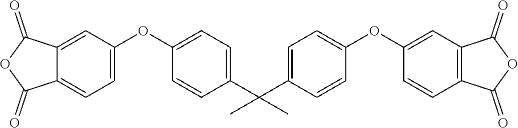 [SMILES: CC(C)(c1ccc(Oc2ccc3c(c2)C(=O)OC3=O)cc1)c1ccc(Oc2ccc3c(c2)C(=O)OC3=O)cc1] |
| meso-Butane-1,2,3,4-tetracarboxylic Dianhydride | 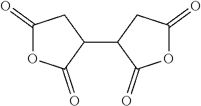 [SMILES: O=C1CC(C2CC(=O)OC2=O)C(=O)O1] |
| 1,2,3,4-Cyclopentanetetracarboxylic Dianhydride | 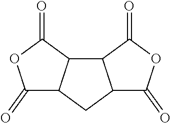 [SMILES: O=C1OC(=O)C2C1CC1C(=O)OC(=O)C12] |
| 4,4′-Sulfonyldiphthalic Anhydride [3,3′,4,4′- Diphenylsulfonetetracarboxylic Dianhydride | 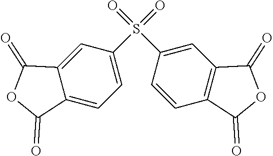 [SMILES: O=C1OC(=O)c2cc(S(=O)(=O)c3ccc4c(c3)C(=O)OC4=O)ccc21] |
| 4,4′-(Hexafluoroisopropylidene)- diphthalic Anhydride | 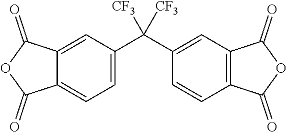 [SMILES: O=C1OC(=O)c2cc(C(c3ccc4c(c3)C(=O)OC4=O)(C(F)(F)F)C(F)(F)F)ccc21] |
| 5-(2,5-Dioxotetrahydrofuryl)-3- methyl-3-cyclohexene-1,2- dicarboxylic Anhydride | 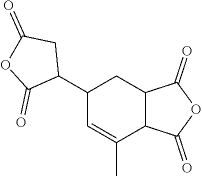 [SMILES: CC1=CC(C2CC(=O)OC2=O)CC2C(=O)OC(=O)C12] |

Another class of exemplary bis-electrophiles are the bis-epoxides. Suitable bis-epoxides have the structure of formula VII:

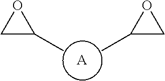

wherein A is selected from the group consisting of C₁₋₂₀ linear or branched alkyl, or C₃₋₂₀ cyclyl, heterocyclyl, aryl or heteroaryl.

In preferred embodiments of the above structure, A is heterocyclyl or heteroaryl. In more preferred embodiments A comprises a heteroaryl capable of 2n+2: dimerization, such as thyminyl and thymine derivatives. Preferred structures of formula VII include:

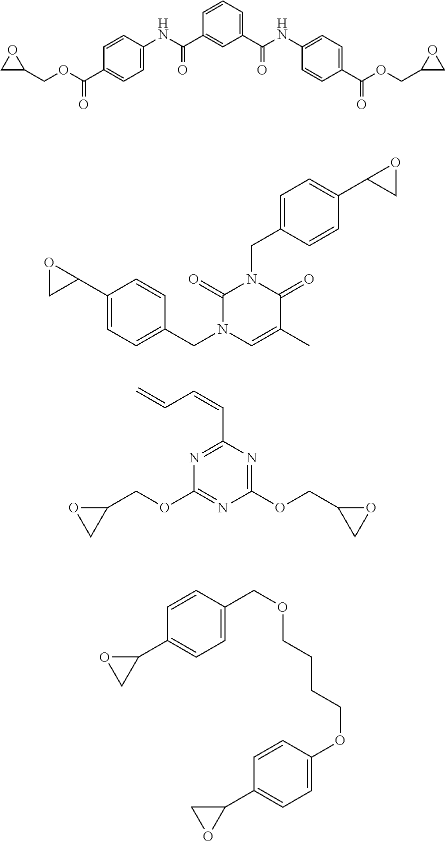

Another class of exemplary bis-electrophiles are the bisphenols. Suitable bisphenols have the structure of formula VIII:

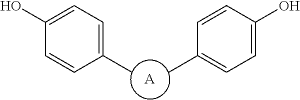

wherein A is selected from the group consisting of C₁₋₂₀ linear or branched alkyl, or C₃₋₂₀ cyclyl, heterocyclyl, aryl or heteroaryl, and further wherein A is not —C(CH₃)₂—.

In preferred embodiments of the above structure, A is heterocyclyl or heteroaryl. In more preferred embodiments A comprises a heteroaryl capable of 2π+2π dimerization, such as thyminyl and thymine derivatives. Preferred structures of formula VIII include:

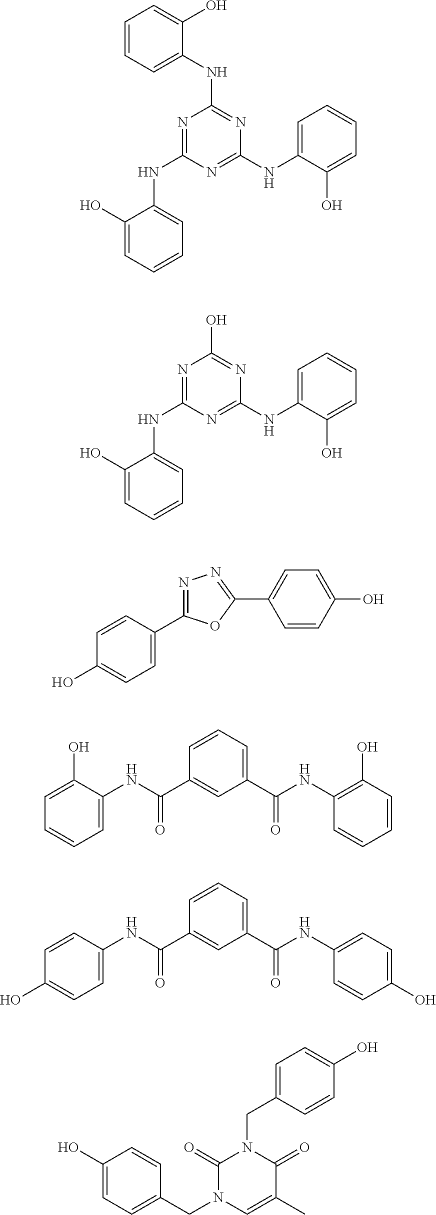 [SMILES: Oc1ccccc1Nc1nc(Nc2ccccc2O)nc(Nc2ccccc2O)n1 ; Oc1nc(Nc2ccccc2O)nc(Nc2ccccc2O)n1 ; Oc1ccc(-c2nnc(-c3ccc(O)cc3)o2)cc1 ; O=C(Nc1ccccc1O)c1cccc(C(=O)Nc2ccccc2O)c1 ; O=C(Nc1ccc(O)cc1)c1cccc(C(=O)Nc2ccc(O)cc2)c1 ; Cc1cn(Cc2ccc(O)cc2)c(=O)n(Cc2ccc(O)cc2)c1=O]

Another class of exemplary bis-electrophiles are the bis-styrenes. Suitable bis-styrenes have the structure of formula IX:

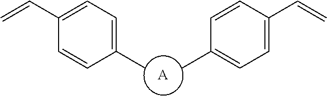

wherein A is selected from the group consisting of C₁₋₂₀ linear or branched alkyl, or C₃₋₂₀ cyclyl, heterocyclyl, aryl or heteroaryl.

In preferred embodiments of the above structure, A is heterocyclyl or heteroaryl. In more preferred embodiments A is a heteroaryl capable of 2π+2π dimerization, such as thymine and thymine derivates. Preferred structures of formula IX include:

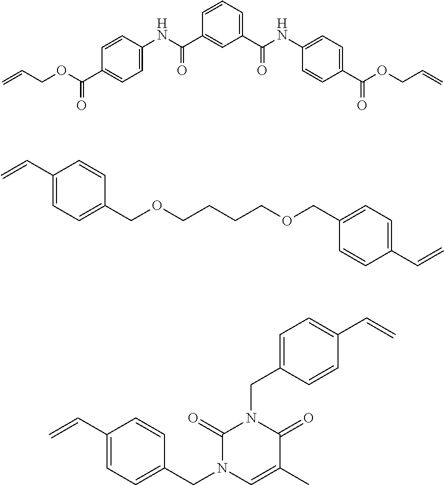

One important aspect of the compositions described herein is the ratio of polynucleophile to bis-electrophile in the crosslinked polymer. In the compositions described herein, the polynucleophile and bis-electrophile may be present in a ratio of between 1:20 and 20:1 polynucleophile:bis-electrophile (mol:mol). Alternatively, they are present in a ratio of between 1:3 and 6:1 polynucleophile: bis-electrophile, or between 1:1 and 6:1 polynucleophile:bis-electrophile.

### Accelerators/Catalysts

Yet another important but optional component of the crosslinked polymer is the accelerator that can accelerate or catalyze the formation process. Accelerators or catalysts described herein are specific for the various classes of crosslinked polymers.

In combination with the polyol/dianhydride embodiments, the accelerators are waxy acids or fatty acids. Preferred accelerators described herein are C₈-C₂₄ alkylcarboxylic acids. The C₅-C₂₄ alkyl group of the accelerator is a linear or branched alkyl group which may optionally include 1, 2 or 3 unsaturated (double) bonds.

In combination with the polyphenol/bis-epoxide or polyepoxide/bis-phenol embodiments, the accelerators are tertiary amines or N-alkylimidazoles. Tertiary amines have the structure NR¹R²R³, wherein R¹, R² and R³ are independently selected from C₁₋₈ linear or branched alkyl, or C₄₋₂₀ aryl, aralkyl or alkaryl. The tertiary amine preferably has a significantly high boiling point, so that it is not vaporized during cure and removed from the formulation. Preferred tertiary amines include 2,4,6-tris(dimethylaminomethyl)phenol (“2,4,6-Tris”) or 1,4-diazabicyclo[2.2.2]octane (DABCO). Preferred N-alkylimidazoles include N-methylimidazole.

In combination with the unsaturated polyester/bis-styrene embodiments, the accelerator is a peroxide catalyst. Preferred peroxide catalysts include t-butylperoxybenzoate and dicumyl peroxide.

In the compositions described herein that comprise an accelerator, the accelerator and polynucleophile may be present in the composition at a ratio of between 1:1 and 1:20 accelerator: polynucleophile (mol:mol). More preferably, they may be present in the composition at a ratio of between 1:2 and 1:10 accelerator:polynucleophile, and most preferably at a ratio of between 1:3 and 1:5.

### Method of Making the Crosslinked Polymers and can Linings

The epoxide-containing crosslinked polymers are simply prepared as follows. The polymer component (polyol, polyphenol, polyepoxide or unsaturated polyester) is dissolved up to 40% by weight in a solvent such as a ketone (preferably methyl ethyl ketone, or MEK). The bifunctional crosslinker (dianhydride, bis-epoxides, bis-phenol or bis-styrene), depending on solubility and matter state (liquid or solid), is added either at full strength or dissolved up to 40% in the solvent. Accelerators or catalysts, if used, are dissolved up to 10% by weight in the solvent. A surfactant such as Tego Glide 410 may be used to improve coating quality and surface wetting, and is dissolved to 1% by weight in the same solvent.

The crosslinked polymer is then formed as follows. The crosslinker component and a surfactant (if used) are combined and stirred with a magnetic stir bar, typically at medium speed (150-250 RPM) for 30 min. to 1 hour. If used, the accelerator or catalyst is added with an additional 15 minutes stirring. Finally, the polymer is added, and stirred at least an additional 30 minutes.

If the crosslinked polymer is used as a coating, this mixture is then coated on a metal substrate, either tin-free steel (TFS) or Aluminum using a wire-wound coating rod (Meier type). Anywhere from a 9 to 12 rod is used, depending on the desired coating thickness and formulation percent solids. The coating is then cured in a vented convention oven for 1-2 minutes at an elevated temperature (such as 220° C.). The coating is then allowed to cool to room temperature before evaluation.

### Method of Making Can Linings

In a production environment, can coatings are typically applied to unfinished cans using a spray method. Depending on the application and formulation, the coating may be sprayed using an organic solvent (for non-food contact applications), an aqueous dispersion (for most food contact applications) or even at 100% solids. To minimize the amount of curing time necessary due to solvent evaporation, the organic or aqueous dispersions/emulsions are typically formulated to 20% solids or higher. However, percent solids must be balanced to achieve appropriate viscosity properties for spraying. After the formulation has been sprayed on the can, the cans are conveyed to a drying/curing oven with temperatures typically varying from 180-250° C., and residence times from 30 seconds to 3 minutes depending on production line speed and coating properties.

### Other Crosslinked Polymer Uses

The crosslinked polymers described herein can also be used as adhesives for metal, wood, ceramic, and other substrates, and for other coatings (such as clear coat, metal corrosion resistance, surface modification, friction reduction). These typically thermoset-type crosslinked polymers are also useful in thermoplastic applications given appropriate molecular weight and crosslink density (in similar fashion to thermoplastic polyurethanes), and can be used in the same way as other thermoplastic materials (e.g., shoe outsoles, etc.).

### EXPERIMENTAL

### Methods

Thickness Measurement:

The thickness of each polymer coating on aluminum substrate was determined using a QNix® 1500 Coating Thickness Gauge. The instrument was zeroed on a clean, uncoated piece of aluminum as described in the instruction manual. Beginning at a location approximately half-way down the coating surface, three measurements were recorded across the width of the sample. The averages of all readings, plus the standard deviations were reported. Target thickness was 6-8 μm.

Tape Peel Test:

The coated surfaces of the samples were marked with a razor blade to produce a square, cross-hatch pattern, consisting of five horizontal lines and five vertical lines, perpendicular to each other and 1-2 mm apart. The crosshatch pattern was then covered with a strip of Scotch Premium Grade Transparent Cellophane Tape 610, with one end folded to produce a tab. After allowing the tape to adhere for a minimum period, typically 10 s, the tape was gripped by the tab and pulled free from the surface. Tape peel resistance of the coating was graded one of two ways: (1) Pass or Fail, with a grade of Pass for complete retention of the coating on the surface, or Fail if any of the coating is removed by the tape; or (2) Pass or Fail, with failure including a visual estimate of what percent of the coating was removed by the tape.

Solvent Rub Test:

The coated samples were placed on a solid surface in a well ventilated area. Using a spray bottle, a small puddle of solvent (acetone, methyl ethyl ketone, or other solvent of choice) was sprayed on the coated surfaces of the samples, and on the applicator tip of a cotton swab. Alternately, the cotton swab can be dipped into a bottle of the solvent, and rewetted as needed. The tip of the swab was then rubbed in a back-and-forth motion over the surface of the coating with each forward-and-return motion counting as one double rub. Double rubs were continued until the coating was rubbed away from the surface down to the substrate. Solvent resistance was reported as double rubs to failure of the coating. Higher solvent rub count was desirable.

Pencil Hardness Test (derived from ASTM Standard D3363-00):

A set of pencils with graphite cores of different hardness were sharpened with a normal pencil sharpener or a utility knife. The hardness of each pencil was graded by the scale 9B-8B-7B-6B-5B-4B-3B-2B-B-HB-F-H-2H-3H-4H-5H-6H-7H-8H-9H, from softest to hardest. The tip of each pencil was polished by holding the pencil at a 900 angle to a sheet of 600 grit carbide abrasive paper and rubbing the tip in a circular motion until a flat, circular surface was obtained. The coated sample to be evaluated was placed on a flat, hard surface, coating side up. Each pencil was held to the surface at a 45° angle and pushed forward with normal hand pressure for a distance of ca. 5-6 mm, preferably making at least three marks for each pencil. Pencil hardness was reported as the “Gauge Hardness” described in the ASTM standard, which is the hardest pencil that will leave the stroke uncut for a length of 3 mm.

Retort Test:

Several coated samples were cut to dimensions 1½″×4″ to provide enough width for a tape peel test and enough length to hang downward a significant distance into a pressure cooker. Identifying markings were made on the uncoated side of each sample with a waterproof marker.

A fabricated wire rack 5.5 in tall was inserted into an 8 L Fagor Rapid Express pressure cooker. Samples were suspended from the rack by clipping the end of the sample to the rack with a binder clip. The pressure cooker was then filled with RO water to a height which covered the lower half of the hanging samples. The lid was then placed on the pressure cooker and the appropriate valves were closed to allow pressure to build. The pressure cooker was then placed on a Deni large scale hot plate with the heat set to maximum, and allowed to heat for 1½ hours. After this period, the valves on the pressure cooker were released and the pressure cooker was removed from the heat. The pressure cooker was placed in a sink half filled with water, and cold water was run over the lid until the water level in the sink reached the lid or the pressure cooker was cooled down, whichever came first. The pressure cooker was removed from the sink, and the lid was removed from the pressure cooker to allow removal of the samples. The location of the water line on the samples was noted and marked, if possible.

Samples were patted dry on paper towels. Two evaluations were performed: (1) The sample was visually inspected to determine if either the submerged or above-water section of the coating experienced haze formation, blistering, or any other coating failure; and (2) The tape peel test was performed on the section of the coating that was submerged and, if desired, on the section of the coating above the water line. The results of this tape peel test were compared to the same test on the original sample.

Manual and 3T-Bend Test:

A solution of electrolyte was prepared by dissolving 5 g of NaCl, 0.015 g of Sodium Benzoate, and 0.085 g of Sodium Docusate in 494.9 g of H₂O, to make a 500 g solution. A sponge was then placed inside a 2″×3″×½″ plastic tray. The electrolyte solution was added to fill the tray and saturate the sponge. The negative lead of the wire for a Wilkins-Anderson Enamel Rater II was clipped to the side of the tray with the end of the clip immersed in the salt solution. The positive lead was retained for samples. A Gardco impact tester (Model No. IM-172RF) was fitted with a 1 kg weight, and its height gauge was set at 20″.

Coated samples were cut to dimension of 2″×2.25″, with the long dimension in the direction of the grain of the metal. Whenever possible, the sample was gripped by the remaining clip of the lead wire and placed coated side down on the saturated sponge in the electrolyte bath. The current produced by the sample was recorded as the baseline conductivity of the coating. The sample was then bent over a ⅛″ wire in a wood frame, preferably perpendicular to the grain of the metal, so that the coating was on the outside of the bend and a ¼″ tab hung over one end of the bend. The sample was then gripped with the wire lead and its current was measured on the outside edge of the bend by placing the coated bent edge of the coated against the sponge saturated with electrolyte solution. The current produced was recorded at the ⅛″ bend conductivity of the coating.

The space within the bend of the sample was then filled with three 1″×2″ pieces of the metal substrate, and placed on the Gardco Impact Tower under a 1½″×2½″ piece of metal. The 1-kg weight was raised to a height of 20″ and dropped on the sample. The three pieces of substrate were removed, and the conductivity of the sample was measured in the same manner as the ⅛″ bend. This measurement was repeated 3-4 times to establish the average and error of the measurement.

Salt Spray/Corrosion Resistance Test: A salt solution (1.5-2.0 kg) of 10 wt % NaCl in water was prepared. Samples were cut to 2″×2″ and marked on the back of the sample, assuming the sample had sufficient area. Only coatings on tin-free steel were tested. Aluminum is not expected to corrode under the test conditions.

Each sample was scored with a 1″×1″ X-shaped mark on the coated surface, using a razor blade or knife to cut through the coating to the substrate. The samples were placed in slots on a red polyethylene rack so that the coated side faced upward at a slight angle (ca. 30°). The rack was placed in a plastic 19″×36″ plastic tray containing 1500 g of the salt solution, and the samples were then sprayed mostly on the coated side with a spray bottle full of the same 10% salt solution. The lid was then placed on the tray, and the tray was allowed to sit for 1 week, interrupted at regular intervals (1-2 days) to apply a fresh salt spray on the samples.

After 7 days, the samples were removed, rinsed with tap water, and patted dry. Evaluation was determined visually by the following criteria:

### Grade Description

1 little or no rust beyond the X mark—no blistering
2 Very small blistering at the X mark only
3 Blistering at score marks plus small pits or blisters in the unmarked portion
4 Noticeable blisters throughout sample, some blisters on edges
5 Complete failure of the coating through blisters and rust
   Digital photos were taken of each sample for data presentation and archival purposes.

Ultraviolet Exposure Test:

A salt rub test was performed on a control coating sample on TFS. Next, three of the same samples on TFS were exposed to 254 nm UV light in a SpectroLinker XL-1500 UV Crosslinker (Spectronics Corporation) for 3, 10, and 60 min, respectively. After each exposure period, a salt rub test was performed and the results were recorded.

### Example 1

### Vinyl Coating with Unsaturated Functionalities and Thymine-Based Crosslinker

### A. Synthesis of 5-methyl-1,3-bis[(4-vinylphenyl)methyl]pyrimidine-2,4-dione (TST2)

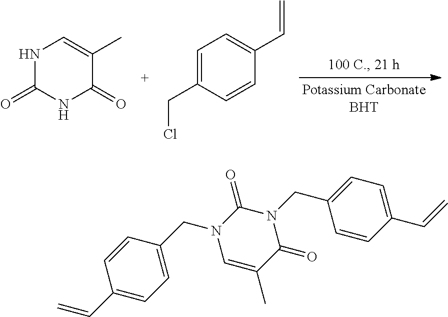

To a 1000 mL round bottom flask containing 20.00 g thymine (Sigma Aldrich, Saint Louis, Mo.) and 53.79 g 90% 4-vinylbenzyl chloride (Sigma Aldrich, Saint Louis, Mo.), 0.035 g butylated hydroxytoluene (Fisher Scientific, Fair Lawn, N.J.) and 46.00 g powdered potassium carbonate (Fisher Scientific, Fair Lawn, N.J.), 500 mL dry N,N-dimethylformamide (DMF) was added. The reaction mixture was heated to 100° C. and stirred for 21 h, then cooled to room temperature. Product was added to 600 mL DI water and washed three times with 500 mL ethyl acetate (EtOAc). The combined organic layer was washed with brine, dried over Na₂SO₄, filtered, and concentrated. The remaining 68.96 g of product and DMF was placed under vacuum overnight to give an off-white solid. The solid was dissolved in DCM and adsorbed onto 800 mL silica gel. The silica mixture was poured onto an additional 800 mL silica gel in a 6″ diameter fritted funnel. Eluted 5×1 L 10% EtOAc/hexanes, 4×1 L 25% EtOAc/Hexanes, and 4×1 L 50% EtOAc. Product was in the 2nd 25% fraction through the 2nd 50% fraction. A small amount of product mixed with more polar impurity was in the 3rd 50% fraction, which was discarded. The remaining product-containing fractions were concentrated and dried under vacuum at 50° C. for 5 h, resulting in 56.06 g (98.62%) clean product.

### B. Polymer Synthesis

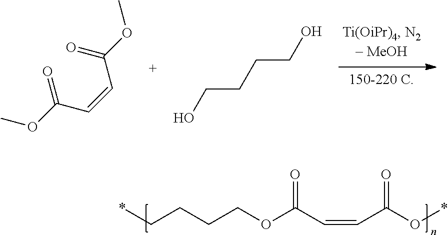

An amount of 1,4-butanediol (Alfa Aesar, Ward Hill, Mass.) equal to 96.16 g and 153.82 g dimethyl maleate (Fisher Acros, Fair Lawn, N.J.) were measured into a 500 mL reaction kettle bottom and covered with a 4-neck reactor top using a cam-loaded clamp. The center neck was fitted with a 9 mm stir shaft, 3″ polytetrafluoroethylene stir paddle, and Teflon stir bushing adapter, which was connected to an IKA overhead stirrer. The right-hand-side neck was fitted with a thermocouple adapter with a J-type stainless steel thermocouple which was inserted into the reaction mix. The adapter also contained a sidearm N₂ adapter for nitrogen from the manifold. The left-hand-side neck was fitted with a Dean-Stark adapter, leading to a Graham Condenser chilled at 15° C. The center front neck was fitted with a silicone rubber septum. The reactor was fitted into a 1000 mL heating mantle with a sand bath, and both heating mantle and thermocouple were attached to a Digi-Sense temperature controller.

The reactor was stirred at 200 rpm, leading to a cloudy mix. The mix was heated under flowing N₂ to 90° C., and during heating the mix clarified at 80° C. Ti(OiPr)₄ was added to the mixture at 80° C., resulting in a thin mist. The temperature was set to 150° C. and distillation began from 150-160° C. Over the course of 5 h distillate was collected. The reaction temperature was increased by 20° C. for the first three hours, up to 220° C. After 5 h, the reaction was stopped and the product was decanted into a pre-weighed steel can. Yield was 91%.

### C. Formulations

Two samples were formulated using polymer, TST2 crosslinker, and initiator. The 32.7 wt % polymer and 65.3 wt % TST2 were dispensed into a plastic container and mixed until homogeneous. The 2 wt % dicumyl peroxide (TCP, Acros Organics, Fair Lawn, N.J.) was weighed immediately and poured into one of the samples under agitation. The 2 wt % t-butylperoxybenzoate (TBPB, Fisher Acros, Fair Lawn, N.J.) was measured with a syringe and dispensed immediately into the other sample under agitation. Both samples were stirred at room temperature for 30 min. Aluminum (Al) and tin-free steel (TFS) plates were baked at 220° C. for 30 min, then washed with acetone. Each formulation was coated onto two Al and two TFS plates using a No. 14 coating rod and cured at 220° C. for 2 min.

### D. Test Results

TABLE 1
Average thickness, solvent rub count, tape peel, pencil hardness, manual
bend, and 3T impact results of vinyl coatings with TCP or TBPB initiator
on Al or TFS substrate.

| | | Avg | Solvent | | | Manual | | 3T | |
|---|---|---|---|---|---|---|---|---|---|
| | | Thickness | Rub | Tape | Pencil | Bend | | Impact | |
| | Sample | (mm) | (Acetone) | Peel | Hardness | A | B | A | B |
| Al | TBPB | 13.5 | 50+ | P | F | 39.0 | 40.2 | 39.4 | 42.8 |
| | DCP | 16.7 | 50+ | F(50%) | H | 39.1 | 38.4 | 38.7 | 38.5 |
| TFS | TBPB | N/A | 50 | F | HB | 34.2 | 33.8 | 37.4 | 36.9 |
| | DCP | N/A | 50+ | F | H | 37.2 | 36.7 | 37.5 | 38.2 |

### Example 2

### Epoxy Coating with Thymine-based Crosslinker

### A. Synthesis of 5-methyl-1,3-bis[[4-(oxiran-2-yl)phenyl]methyl]pyrimidine-2,4-dione (TEP2)

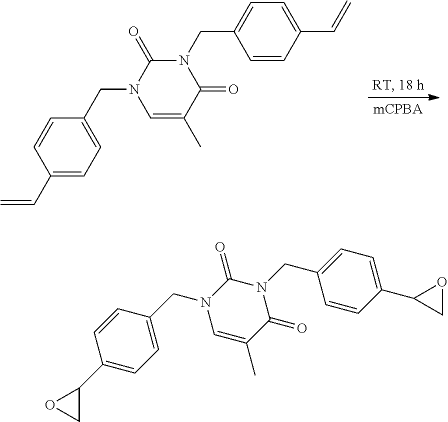 [SMILES: C=Cc1ccc(Cn2cc(C)c(=O)n(Cc3ccc(C=C)cc3)c2=O)cc1 ; Cc1cn(Cc2ccc(C3CO3)cc2)c(=O)n(Cc2ccc(C3CO3)cc2)c1=O]

To a 500-mL nitrogen-purged round bottom flask containing 4.65 g TST2, 126 mL dichloroethane was added via cannula. The mixture was stirred at room temperature until TST2 fully dissolved. The 9.60 g 70% meta-Chloroperoxybenzoic acid (Sigma Aldrich, St. Louis, Mo.) was then added and stirred at room temperature overnight. After 18 h, the TST2 was consumed and 100 mL of sat. NaHCO₃ and 50 mL of 10% Na₂S₂O₃ was added. The reaction mixture was stirred at room temperature for 1 h, after which the layers were separated. The aqueous layer was extracted 2×100 mL with dichloromethane. The combined organic layer was washed with 100 mL sat. NaHCO₃, dried over Na₂S₂O₃, filtered, and concentrated. The 6.15 g concentrate was purified with 0 to 70% EtOAc/hexane on silica gel, yielding 2.74 g (54.10%) clean product.

### B. Formulations

Five epoxy samples were formulated using 1% Tego Glide 410 surfactant (Evonik Industries, Germany) in methyl ethyl ketone (MEK), 10% 2,4,6-Tris(dimethylaminomethyl)phenol catalyst (Sigma Aldrich, St. Louis, Mo.) in MEK, 40% poly(4-vinylphenol-co-methyl methacrylate) crosslinker (p(vPh-co-MMA), Sigma Aldrich, St. Louis, Mo.) in MEK, and varying amounts of 1,4-cyclohexanedimethanol diglycidyl ether (CHDMEG, Sigma Aldrich, St. Louis, Mo.) and TEP2 as the epoxy resin. An amount of Tego Glide 410 equal to 5.78 wt % of the sample and TEP2 equal to 0, 10, 20, 30, or 40 wt % of the total epoxy resin (37.59 wt % of sample) were combined at room temperature in five separate containers. An amount of 2,4,6-Tris equal to 6.02 wt % of the sample was added and stirred for approximately 15 min using a magnetic stir bar. An amount of p(vPh-co-MMA) equal to 50.61 wt % of the sample and CHDMEG equal to 100, 90, 80, 70, and 60 percent of the total epoxy resin were added and stirred until homogeneous. Al and TFS plates were baked at 220° C. for 30 min, then washed with acetone. Each formulation was coated onto Al and TFS plates using a No. 14 rod and cured at 220° C. for 2 min.

### C. Test Results

TABLE 2
Average thickness, solvent rub count, pencil hardness, retort steamed, retort submerged,
manual bend, and 3T impact results of epoxy coatings with 0, 10, 20, 30, or 40% TST2 on
aluminum or TFS substrate.

| | | Avg | Solvent | | | | Manual | | 3T | |
|---|---|---|---|---|---|---|---|---|---|---|
| | % | Thickness | Rub | Pencil | Retort | Retort | Bend | | Impact | |
| | TEP2 | (mm) | (MEK) | Hardness | (steamed) | (submerged) | A | B | A | B |
| Aluminum | 0% | 5.8 | 50 | 6H | P | P | 1.3 | 1.6 | 36.3 | 36.0 |
| | 10% | 5.8 | 50 | 6H | P | P | 12.1 | 6.3 | 27.0 | 10.6 |
| | 20% | 6.5 | 100+ | 7H | P | P | 16.8 | 2.6 | 5.2 | 9.0 |
| | 30% | 7.7 | 100+ | 7H | P | P | 14.9 | 15.5 | 37.8 | 3.3 |
| | 40% | 6.3 | 100+ | 6H | P | P | 13.7 | 1.0 | 9.8 | 42.6 |
| TFS | 0% | N/A | 50 | 4H | SF | F | 2.0 | 0.0 | 35.7 | 33.8 |
| | 10% | N/A | 50 | 4H | P | SF | 0.0 | 17.2 | 37.5 | 35.5 |
| | 20% | N/A | 100+ | 7H | P | SF | 14.0 | 3.0 | 38.1 | 40.4 |
| | 30% | N/A | 100+ | 6H | P | F | 6.0 | 6.4 | 39.6 | 40.3 |
| | 40% | N/A | 100+ | 6H | PF | F | 4.3 | 3.2 | 34.6 | 35.2 |

A UV exposure test was performed on 10% TEP2 formulation on TFS. The control, 3 min, and 10 min samples shared similar results of 4H hardness, resilience at 50 MEK wipes, and failure at 100 MEK wipes. However, after 60 min of irradiation, the hardness remained 4H and the coating was resilient up to 200 MEK wipes.

### Example 3

### Polyol/Anhydride Coating

### A. Formulations

A polyol solution was formulated by heating 47.5 g POVAL LM-20 (Kuraray Co, Japan) and 130 mL DI water to 90° C. in a glass vial. Once the POVAL LM-20 melted, the vial was removed from the heat, 60 mL of isopropyl alcohol was added, and the solution was mixed until homogeneous. The final solution contained 20% POVAL LM-20, 25% IPA, and 55% water by weight.

Next, 0.4 g linseed oil (Recochem, Canada) was added to 20 g polyol solution in a 30 mL vial. The vial was probe-sonicated using a MISONIC S-4000 ULTRASONIC DISINTEGRATOR SONICATOR LIQUID PROCESSOR 600 W, outfitted with a microtip and set at 10 Amp for 5 min, with intervals of 1 min on and 30 s off. The solution was then divided into 4 vials, each containing 4 g of material.

Amounts of 3,3,4,4-benzophenonetetracarboxylic dianhydride (BTDA, Acros Organics, Fair Lawn, N.J.) equal to 2.5, 5, 10, and 25 mol % of the polyvinyl alcohol (PVA) in POVAL LM-20 were calculated by first assuming 37.5 mol % of PVA in POVAL LM-20 (33-42% hydrolysis), which is 23.49 wt %. Since 19.61 wt % of the 4 g polyol solution is POVAL LM-20, the amount of PVA was determined to be 184 mg and 4.20 mmol. However, since BTDA is bifunctional, 2.10 mmol of BTDA is the molar equivalent to 4.20 mmol PVA. Using this molar ratio, amounts of BTDA equal to 2.5, 5, 10, and 25% of 2.10 mmol were determined to be 16.9, 33.7, 67.5, and 168.6 mg, respectively. The BTDA was added and the vials were mixed using the same sonication procedure. Al plates were baked at 220° C. for 30 min, then washed with acetone. The resulting 2.5, 5, 10, and 25 mol % BTDA formulations were coated onto the pre-baked Al substrates using #36, 34, 32, and 30 coating bars, respectively. The coatings were then immediately cured in a 200° C. oven for 60 sec.

### B. Test Results

TABLE 3
Average thickness, solvent rub count, pencil hardness, tape peel, retort steamed, retort
submerged, manual bend, and 3T impact results of polyol/anhydride coatings with 2.5,
5, 10, and 25% BTDA and linseed oil on aluminum substrate.

| | Avg | Solvent | | | | | Manual | | 3T | |
|---|---|---|---|---|---|---|---|---|---|---|
| % | Thickness | Rub | Pencil | Tape | Retort | Retort | Bend | | Impact | |
| BTDA | (mm) | (MEK) | Hardness | Peel | (steamed) | (submerged) | A | B | A | B |
| 2.5% | 7.8 | 5 | F | P | P | P | N/A | N/A | N/A | N/A |
| 5% | 7.9 | 1 | 4H | P | P | P | N/A | N/A | N/A | N/A |
| 10% | 7.2 | 5 | HB | P | P | P | 0 | 0 | 25.0 | 25.2 |
| 25% | 9.7 | 100+ | F | P | P | P | 0 | 0 | 23.6 | 23.6 |

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope. The foregoing examples of the related art and limitations are intended to be illustrative and not exclusive. Other limitations of the related art will become apparent to those of skill in the art upon a reading of the specification and a study of the drawings or figures as provided herein. The entire disclosures of all documents cited throughout this application are incorporated herein by reference.

What is claimed is:

1. A spray composition for a can lining comprising a polynucleophile and a bis-electrophile.

2. The composition of claim 1 wherein the polynucleophile/bis-electrophile pair is selected from the group consisting of polyol/dianhydride, polyphenol/bis-epoxide, polyepoxide/bisphenol, and unsaturated polyester/bis-styrene.

3. The composition of claim 2 comprising a polyol and a dianhydride.

4. The composition of claim 3 wherein the dianhydride is selected from the group consisting of benzophenone-3,3′,4,4′-tetracarboxylic dianhydride, 4,4′-oxydiphthalic anhydride, 4,4′-biphthalic anhydride, and bicyclo[2.2.2]oct-7-ene-2,3,5,6-tetracarboxylic dianhydride.

5. The composition of claim 3 wherein the polyol is selected from the group consisting of polyvinyl alcohols (PVA), styrene-allyl alcohol copolymers (SAA), polyvinyl butyrals (PVB), ethylene vinyl alcohol copolymers, 1,4-butanediol, 1,3-propanediol, 1,6-hexanediol, diethylene glycol, 1,1,1-tris(hydroxymethyl)propane, triethanolamine and mixtures of same, diols and triols.

6. The composition of claim 2 comprising a polyphenol and a bis-epoxide.

7. The composition of claim 6 wherein the polyphenol has the structure of formula I: 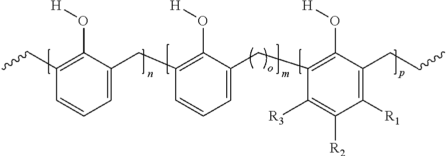
wherein n, m, and p are integers together denoting the fraction of each monomer or group in the polymer;
o=1, 2 or 3; and
R¹, R², and R³ are independently selected from the group consisting of H and C₁₋₈ linear or branched alkyl.

8. The composition of claim 6 wherein the bis-epoxide has the structure of formula VII: 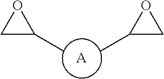
wherein A is selected from the group consisting C₁₋₂₀ linear or branched alkyl, or C₃₋₂₀ cyclyl, heterocyclyl, aryl or heteroaryl.

9. The composition of claim 2 comprising a polyepoxide and a bisphenol.

10. The composition of claim 9 wherein the polyepoxide has the structure of formula II:

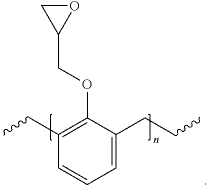

11. The composition of claim 9 wherein the bisphenol has the structure of formula VIII: 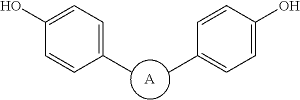
wherein A is selected from the group consisting of C₁₋₂₀ linear or branched alkyl, or C₃₋₂₀ cyclyl, heterocyclyl, aryl or heteroaryl, and further wherein A is not —C(CH₃)₂—.

12. The composition of claim 2 comprising an unsaturated polyester and a bis-styrene.

13. The composition of claim 12 wherein the unsaturated polyester is selected from the structures of formulae IV, V and VI: 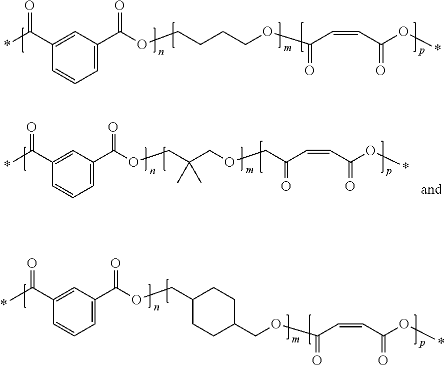
wherein
n, m, and p are integers together denoting the fraction of each monomer or group in the polymer.

14. The composition of claim 12 wherein the bis-styrene has the structure of formula IX: 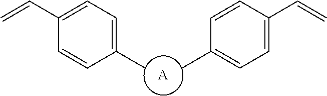
wherein A is selected from the group consisting of C₁₋₂₀ linear or branched alkyl, or C₃₋₂₀ cyclyl, heterocyclyl, aryl or heteroaryl.

15. A bis-epoxide selected from the group consisting of:

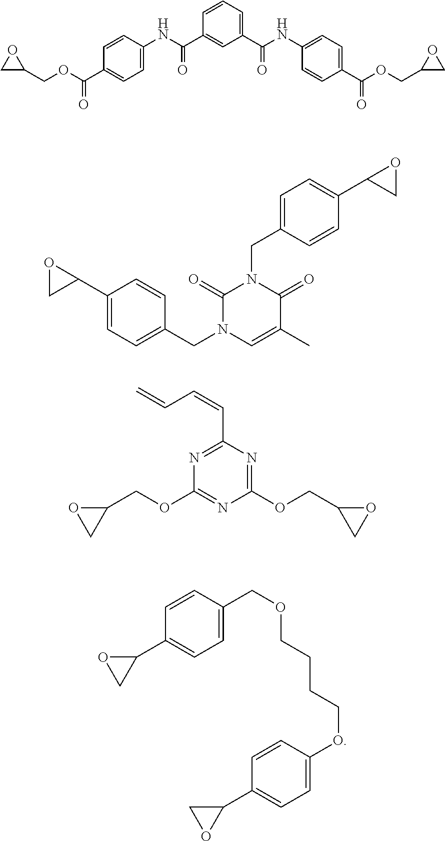

16. A bisphenol selected from the group consisting of:

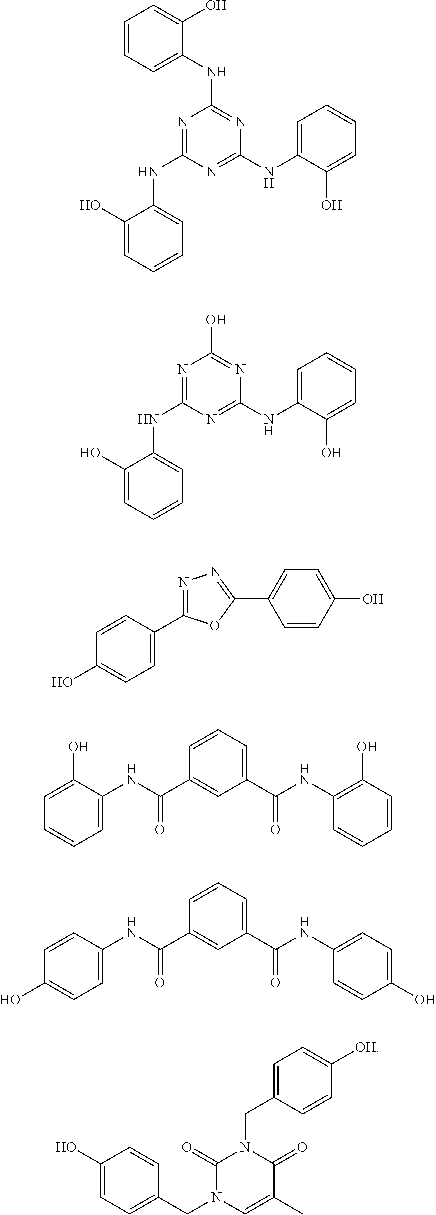 [SMILES: Oc1ccccc1Nc1nc(Nc2ccccc2O)nc(Nc2ccccc2O)n1 ; Oc1nc(Nc2ccccc2O)nc(Nc2ccccc2O)n1 ; Oc1ccc(-c2nnc(-c3ccc(O)cc3)o2)cc1 ; O=C(Nc1ccccc1O)c1cccc(C(=O)Nc2ccccc2O)c1 ; O=C(Nc1ccc(O)cc1)c1cccc(C(=O)Nc2ccc(O)cc2)c1 ; Cc1cn(Cc2ccc(O)cc2)c(=O)n(Cc2ccc(O)cc2)c1=O]

17. A bis-styrene selected from the group consisting of:

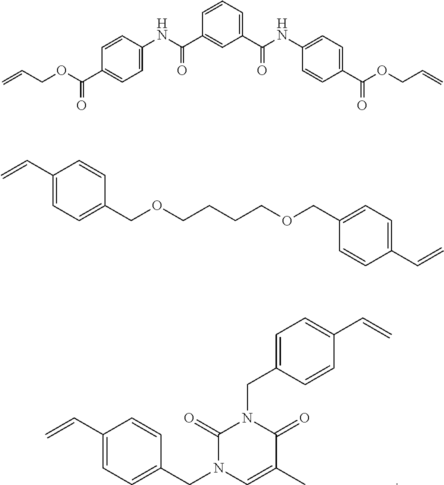

18. An unsaturated polyester polymer selected from the structures of formulae IV, V and VI: 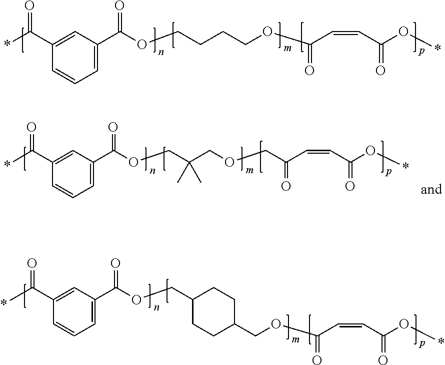
wherein
n, m, and p are integers together denoting the fraction of each monomer or group in the polymer.

19. A composition comprising: (a) a bis-electrophile; (c) a polynucleophile; and (d) an accelerator.

20. A method of making a crosslinked polymer, the method comprising the steps of:
a. dissolving a bis-electrophile in a solvent to form a solution,
b. optionally adding an accelerator to the solution,
c. after steps (a) and (b), adding a polynucleophile to the solution, and then
d. stirring the resultant solution.

21. A crosslinked polymer made by the method of claim 20.
